(19) United States
(12) Patent Application Publication
(10) Pub. No.: US 2020/0374306 A1
(43) Pub. Date: Nov. 26, 2020

(54) NETWORK TRAFFIC ANOMALY DETECTION METHOD, APPARATUS, COMPUTER DEVICE AND STORAGE MEDIUM

(71) Applicant: ZICT Technology Co., Ltd, Shenzhen (CN)

(72) Inventor: Qingguo DAI, Shenzhen (CN)

(73) Assignee: ZICT Technology Co., Ltd, Shenzhen (CN)

(21) Appl. No.: 16/763,687

(22) PCT Filed: Jul. 25, 2018
(86) PCT No.: PCT/CN2018/097042

§ 371 Date: May 13, 2020

(30) Foreign Application Priority Data
Nov. 14, 2017 (CN) 201711119733.7

(51) Int. Cl. H04L 29/06; H04L 12/26; H04L 12/24

(52) U.S. Cl. CPC H04L 63/1425; H04L 41/145; H04L 43/08

(57) ABSTRACT

Provided are a network traffic anomaly detection method and apparatus, a computer device and a storage medium. The method includes: collecting network traffic data in real time, and storing the network traffic data in a first preset database; determining network traffic anomaly detection model data according to network traffic data collected within a preset time period; and determining whether network traffic data collected after the preset time period is anomalous according to the network traffic anomaly detection model data.

### CROSS-REFERENCE TO RELATED APPLICATION

This is a National Stage application, under 37 U.S.C. 371, of International application No. PCT/CN2018/097042, filed on Jul. 25, 2018, which claims priority to Chinese patent application No. 201711119733.7 filed on Nov. 14, 2017, disclosures of which are incorporated herein by reference in their entireties.

### TECHNICAL FIELD

The present disclosure relates to the field of network security, for example, relates to a network traffic anomaly detection method and apparatus, a computer device and a computer-readable storage medium.

### BACKGROUND

Some anomalous network traffic is generally caused by propagation of worms, an attack on a disk operating system (DOS), an attack on a distributed denial of service (DDOS), a botnet and other network attack behaviors, a network configuration error or an occasional line interruption. The anomalous traffic is mixed with normal traffic and causes great harm to a network.

In the related art, it is generally detected whether network traffic is anomalous by manually configuring a determination rule, that is, a user formulates a rule or uses specific grammar of an application itself to configure the rule, which has a high false positive rate and a low detection rate, and is difficult to adapt to a rapidly developing and changing network.

### SUMMARY

The present disclosure provides a network traffic anomaly detection method. The method includes: collecting network traffic data in real time, and storing the network traffic data in a first preset database; determining network traffic anomaly detection model data according to network traffic data collected within a preset time period stored in the first preset database; and determining whether network traffic data collected after the preset time period is anomalous according to the network traffic anomaly detection model data.

The present disclosure further provides a network traffic anomaly detection apparatus, which includes a collection unit, an establishment unit and a determining unit. The collection unit is configured to collect network traffic data in real time, and store the network traffic data in a first preset database. The establishment unit is configured to determine network traffic anomaly detection model data according to network traffic data collected within a preset time period stored in the first preset database. The determining unit is configured to determine whether network traffic data collected after the preset time period is anomalous according to the network traffic anomaly detection model data.

The present disclosure further provides a computer device, including a processor which, when executing computer programs stored in a memory, implements any network traffic anomaly detection method described above.

The present disclosure further provides a computer-readable storage medium. The computer-readable storage medium stores computer programs thereon, where the computer programs, when executed by a processor, implement any network traffic anomaly detection method described above.

The network traffic anomaly detection method and apparatus, the computer device and the storage medium provided by the present disclosure can improve network traffic anomaly detection efficiency, achieve an anomaly analysis of unknown network traffic, and improve network traffic anomaly detection accuracy, thereby applicable to various traffic types and satisfying the requirement of real-time anomaly detection.

### BRIEF DESCRIPTION OF DRAWINGS

FIG. 1 is a schematic flowchart of a network traffic anomaly detection method according to an embodiment.

FIG. 2 is a schematic block diagram of a network traffic anomaly detection apparatus according to an embodiment.

FIG. 3 is a schematic flowchart of a network traffic anomaly detection method according to another embodiment.

FIG. 4 is a schematic flowchart of a network traffic anomaly detection method according to an embodiment.

FIG. 5 is a diagram of a network traffic anomaly display interface according to an embodiment.

### DETAILED DESCRIPTION

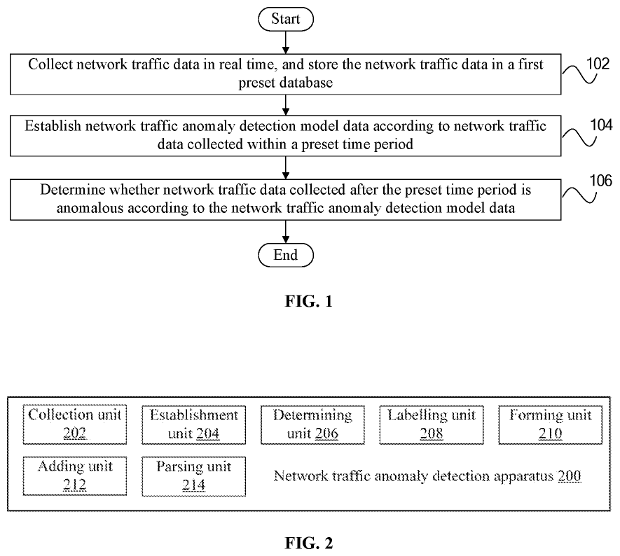

FIG. 1 is a schematic flowchart of a network traffic anomaly detection method according to an embodiment. As shown in FIG. 1, the network traffic anomaly detection method according to the embodiment includes steps described below.

In step 102, network traffic data is collected in real time and stored in a first preset database.

In step 104, network traffic anomaly detection model data is determined according to network traffic data collected within a preset time period.

In step 106, it is determined whether network traffic data collected after the preset time period is anomalous according to the network traffic anomaly detection model data.

In the embodiment, the network traffic data is collected in real time and stored in the first preset database, which achieves real-time collection and storage of the network traffic data, and provides data support for determination of the network traffic anomaly detection model data. The network traffic anomaly detection model data is determined according to the network traffic data collected within the preset time period, so as to realize the form of the network traffic anomaly detection model data, and the model data is continuously updated with time, which reduces the occurrence of inaccurate detection due to a conventional rule and a human error. It is determined whether the network traffic data collected after the preset time period is anomalous according to the network traffic anomaly detection model data, which improves network traffic anomaly detection efficiency, achieves an anomaly analysis of unknown network traffic, and improves network traffic anomaly detection accuracy, thereby applicable to various traffic types, satisfying the requirement of real-time anomaly detection, and achieving automated configurations of anomalous data detection. The preset time period may refer to one month before a previous day. Duration of the preset time period remains unchanged, and starting and ending moments of the preset time period change with time. For example, a time period of one month before a previous day of current time is the preset time period; and if the current time changes, the starting and ending moments of the preset time period also change.

In an embodiment, the step in which a network traffic anomaly detection model is determined according to the network traffic data collected within the preset time period includes steps described below. A first outlier factor corresponding to each of network traffic data collected within the preset time period is determined based on a local outlier factor (LOF) algorithm. In response to determining that the first outlier factor is greater than a first preset threshold, the each of the network traffic data corresponding to the first outlier factor is labelled with an anomalous state. In response to determining that the first outlier factor is less than or equal to the first preset threshold, the each of the network traffic data corresponding to the first outlier factor is labelled with a normal state. The network traffic anomaly detection model data is determined according to the labelled each of the network traffic data based on machine learning. The labelled each of the network traffic data includes network traffic data with a label indicating a normal data state and network traffic data with a label indicating an anomalous data state.

In the embodiment, the first outlier factor corresponding to each of the network traffic data collected within the preset time period is determined based on the local outlier factor algorithm, which is beneficial for the classification of each of the network traffic data within the preset time period; in response to determining that the first outlier factor is greater than the first preset threshold, the each of the network traffic data corresponding to the first outlier factor is labelled with an anomalous state, and in response to determining that the first outlier factor is less than or equal to the first preset threshold, the each of the network traffic data corresponding to the first outlier factor is labelled with a normal state, so as to realize the label for the each of the network traffic data within the preset time period and provides data support for the machine learning; and the network traffic anomaly detection model data is determined based on the labelled network traffic data and the machine learning. The reasonable network traffic anomaly detection model data is beneficial for the anomaly analysis of the unknown network traffic, improves the network traffic anomaly detection accuracy, is applicable to the various traffic types, and satisfies the requirement of real-time anomaly detection.

The first preset threshold may be set to 1 or may be determined according to a quantity of the network traffic data within the preset time period and detection accuracy.

In addition, the each of the network traffic data collected within the preset time period may also be analyzed directly by the machine learning to determine the network traffic anomaly detection model data.

In an embodiment, the step in which it is determined whether the network traffic data collected after the preset time period is anomalous according to the network traffic anomaly detection model data includes steps described below. A data set is formed according to the network traffic data collected after the preset time period and the network traffic anomaly detection model data. A second outlier factor of the network traffic data collected after the preset time period in the data set is determined based on the local outlier factor algorithm. In response to determining that the second outlier factor is greater than a second preset threshold, it is determined that the network traffic data corresponding to the second outlier factor is anomalous. In response to determining that the second outlier factor is less than or equal to the second preset threshold, it is determined that the network traffic data corresponding to the second outlier factor is normal. The second preset threshold is affected by a traffic change within one time period and traffic changes of different Internet protocol (IP) ports in the one time period.

In the embodiment, the data set is formed according to the network traffic data and the network traffic anomaly detection model data, which provides data support for a calculation of an outlier factor using the local outlier factor algorithm; the second outlier factor of the network traffic data in the data set is determined based on the local outlier factor algorithm, which is beneficial for determining whether the network traffic data is anomalous; in response to determining that the second outlier factor is greater than the second preset threshold, it is determined that the network traffic data corresponding to the second outlier factor is anomalous, and in response to determining that the second outlier factor is less than or equal to the second preset threshold, it is determined that the network traffic data corresponding to the second outlier factor is normal, which achieves real-time detection of the network traffic data, reduces a false positive rate, improves a detection rate, is beneficial for reducing harm of anomalous traffic to a network, improves network security, is applicable to the various traffic types, and satisfies the requirement of real-time anomaly detection.

The local outlier factor algorithm is a representative algorithm among density-based outlier detection methods. The algorithm is used for calculating one local outlier factor (LOF) for each point in the data set. The LOF is used for determining whether a point in the data set is an outlier point or a normal point. If the point is the outlier point, an anomaly exists.

In an embodiment, the method further includes steps described below. In response to determining that the network traffic data collected after the preset time period is anomalous, the network traffic data collected after the preset time period is added to a second preset database. Network traffic data in the second preset database is parsed and counted to obtain a counting result, and a display content of an anomaly display interface is updated according to the counting result. An IP, a protocol port and the like of original network traffic may be parsed.

In the embodiment, in response to determining that the network traffic data is anomalous, the network traffic data is added to the second preset database, the network traffic data in the second preset database is parsed and counted, and the corresponding anomaly display interface is updated to display anomaly information of the network traffic data to a user, which is beneficial for the user to perform further processing in time, reduces the harm of anomalous traffic to the network, and improves the network security.

In an embodiment, the network traffic data includes an access time period, an access source IP address, an access destination IP address, an access source port, an access destination port, a number of input bytes and a number of output bytes.

In the embodiment, the network traffic data includes the access time period, the access source IP address, the access destination IP address, the access source port, the access destination port, the number of input bytes and the number of output bytes. These access behaviors help to comprehensively determine whether the network traffic data is anomalous. When one of them is anomalous, the network traffic data is considered to be anomalous. Therefore, the network traffic data detection accuracy and the network security are further improved.

FIG. 2 is a schematic block diagram of a network traffic anomaly detection apparatus 200 according to an embodiment.

As shown in FIG. 2, the network traffic anomaly detection apparatus 200 includes a collection unit 202, an establishment unit 204 and a determining unit 206.

The collection unit 202 is configured to collect network traffic data in real time, and store the network traffic data in a first preset database.

The establishment unit 204 is configured to determine network traffic anomaly detection model data according to network traffic data collected within a preset time period stored in the first preset database.

The determining unit 206 is configured to determine whether network traffic data collected after the preset time period is anomalous according to the network traffic anomaly detection model data.

In the embodiment, the network traffic data is collected in real time and stored in the first preset database, which achieves real-time collection and storage of the network traffic data, and provides data support for determination of the network traffic anomaly detection model data; the network traffic anomaly detection model data is determined according to the network traffic data collected within the preset time period, so as to realize the form of the network traffic anomaly detection model data, and the model data may be continuously updated with time, which reduces the occurrence of inaccurate detection due to a conventional rule and a human error. It is determined whether the network traffic data collected after the preset time period is anomalous according to the network traffic anomaly detection model data, which improves network traffic anomaly detection efficiency, achieves an anomaly analysis of unknown network traffic, and improves network traffic anomaly detection accuracy, thereby applicable to various traffic types and satisfying the requirement of real-time anomaly detection.

The preset time period may refer to one month before a previous day. Duration of the preset time period remains unchanged, and starting and ending moments of the preset time period change with time.

In an embodiment, the determining unit 206 is further configured to determine a first outlier factor corresponding to each of the network traffic data collected within the preset time period based on a local outlier factor algorithm. The network traffic anomaly detection apparatus 200 further includes a labelling unit 208. The labelling unit 208 is configured to: in response to determining that the first outlier factor is greater than a first preset threshold, label the each of the network traffic data corresponding to the first outlier factor with an anomalous state. The labelling unit 208 is further configured to: in response to determining that the first outlier factor is less than or equal to the first preset threshold, label the each of the network traffic data corresponding to the first outlier factor with a normal state. The establishment unit 204 is further configured to determine the network traffic anomaly detection model data according to the labelled each of the network traffic data based on machine learning.

In the embodiment, the first outlier factor corresponding to the each of the network traffic data collected within the preset time period is determined based on the local outlier factor algorithm, which is beneficial for the classification of the each of the network traffic data within the preset time period; in response to determining that the first outlier factor is greater than the first preset threshold, the each of the network traffic data corresponding to the first outlier factor is labelled with an anomalous state, and in response to determining that the first outlier factor is less than or equal to the first preset threshold, the each of the network traffic data corresponding to the first outlier factor is labelled with a normal state, so as to realize the label for the each of the network traffic data within the preset time period and provides data support for the machine learning; and the network traffic anomaly detection model data is determined based on the labelled network traffic data and the machine learning. The reasonable network traffic anomaly detection model data is beneficial for the anomaly analysis of the unknown network traffic, improves the network traffic anomaly detection accuracy, is applicable to the various traffic types, and satisfies the requirement of real-time anomaly detection.

The first preset threshold may be set to 1 or may be determined according to a quantity of the network traffic data within the preset time period and detection accuracy.

In addition, the each of the network traffic data collected within the preset time period may also be analyzed directly by the machine learning to determine the network traffic anomaly detection model data.

In an embodiment, a forming unit 210 is further included. The forming unit 210 is configured to form a data set according to the network traffic data collected after the preset time period and the network traffic anomaly detection model data. The determining unit 206 is further configured to determine a second outlier factor of the network traffic data collected after the preset time period in the data set based on the local outlier factor algorithm. The determining unit 206 is further configured to: in response to determining that the second outlier factor is greater than a second preset threshold, determine that the network traffic data corresponding to the second outlier factor is anomalous. The determining unit 206 is further configured to: in response to determining that the second outlier factor is less than or equal to the second preset threshold, determine that the network traffic data corresponding to the second outlier factor is normal.

In the embodiment, the data set is formed according to the network traffic data and the network traffic anomaly detection model data, which provides data support for a calculation of an outlier factor using the local outlier factor algorithm; the second outlier factor of the network traffic data in the data set is determined based on the local outlier factor algorithm, which is beneficial for determining whether the network traffic data is anomalous; in response to determining that the second outlier factor is greater than the second preset threshold, it is determined that the network traffic data corresponding to the second outlier factor is anomalous, and in response to determining that the second outlier factor is less than or equal to the second preset threshold, it is determined that the network traffic data corresponding to the second outlier factor is normal, which achieves real-time detection of the network traffic data, reduces a false positive rate, improves a detection rate, is beneficial for reducing harm of anomalous traffic to a network, improves network security, is applicable to the various traffic types, and satisfies the requirement of real-time anomaly detection.

The local outlier factor (LOF) algorithm is a representative algorithm among density-based outlier detection methods. The algorithm is used for calculating one local outlier factor (LOF) for each point in the data set. The LOF is determined to determine whether a point in the data set is an outlier point or a normal point. If the point is the outlier point, an anomaly exists.

In an embodiment, an adding unit 212 and a parsing unit 214 are further included. The adding unit 212 is configured to: in response to determining that the network traffic data collected after the preset time period is anomalous, add the network traffic data collected after the preset time period to a second preset database. The parsing unit 214 is configured to parse and count network traffic data in the second preset database to obtain a counting result, and update a display content of an anomaly display interface according to the counting result.

In the embodiment, in response to determining that the network traffic data is anomalous, the network traffic data is added to the second preset database, the network traffic data in the second preset database is parsed and counted, and the corresponding anomaly display interface is updated to display anomaly information of the network traffic data to a user, which is beneficial for the user to perform further processing in time, reduces the harm of anomalous traffic to the network, and improves the network security.

In an embodiment, the network traffic data includes an access time period, an access source IP address, an access destination IP address, an access source port, an access destination port, a number of input bytes and a number of output bytes.

In the embodiment, the network traffic data includes the access time period, the access source IP address, the access destination IP address, the access source port, the access destination port, the number of input bytes and the number of output bytes. These access behaviors help to comprehensively determine whether the network traffic data is anomalous. When one of them is anomalous, the network traffic data is considered to be anomalous. Therefore, the network traffic data detection accuracy and the network security are further improved.

An embodiment provides a computer device, including a processor which, when executing computer programs stored in a memory, implements the network traffic anomaly detection method according to any one of the embodiments described above.

In the embodiment, the computer device includes the processor which, when executing the computer programs stored in the memory, implements the network traffic anomaly detection method according to any one of the embodiments described above, and the computer device has all of the beneficial effects of the network traffic anomaly detection method according to any one of the embodiments described above.

An embodiment provides a computer-readable storage medium. The computer-readable storage medium stores computer programs thereon, where the computer programs, when executed by a processor, implement the network traffic anomaly detection method according to any one of the embodiments described above.

In the embodiment, the computer-readable storage medium stores the computer programs thereon, where the computer programs, when executed by the processor, implement the network traffic anomaly detection method according to any one of the embodiments described above, and the computer-readable storage medium has all of the beneficial effects of the network traffic anomaly detection method according to any one of the embodiments described above.

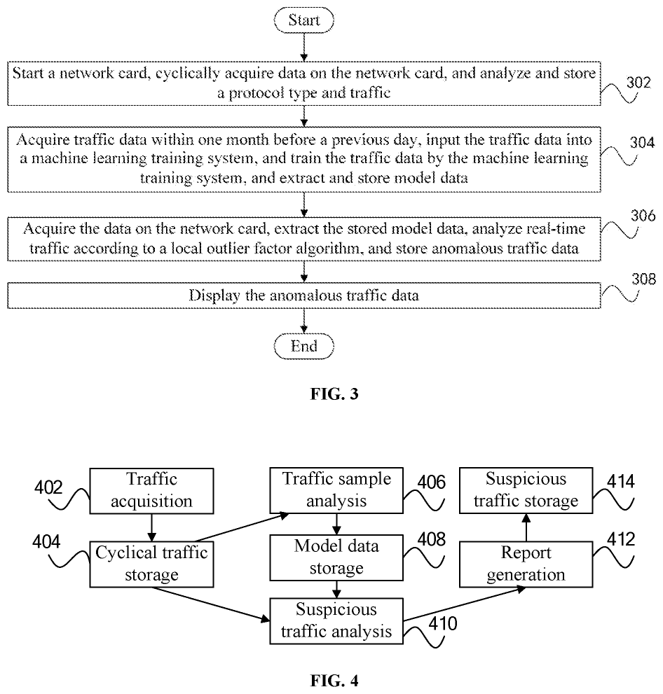

FIG. 3 is a schematic flowchart of a network traffic anomaly detection method according to another embodiment. As shown in FIG. 3, the network traffic anomaly detection method according to the embodiment includes steps described below.

In step 302, a network card is started, data on the network card is cyclically acquired, and a protocol type and traffic are analyzed and stored.

In step 304, traffic data within one month before a previous day is acquired, inputted into a machine learning training system, and trained by the machine learning training system, so that model data is extracted and stored.

In step 306, the data on the network card is acquired, the stored model data is extracted, real-time traffic data is analyzed according to a local outlier factor algorithm, and anomalous traffic data is stored. Original real-time traffic data is acquired from the network card.

In step 308, the anomalous traffic data is displayed.

An anomaly detection rule provided by the embodiment can be updated with time, which improves network traffic anomaly detection accuracy and efficiency, is applicable to various traffic types, and satisfies the requirement of real-time anomaly detection.

FIG. 4 is a schematic flowchart of a network traffic anomaly detection method according to another embodiment. As shown in FIG. 4, the network traffic anomaly detection method according to the embodiment includes steps described below.

In step 402, traffic acquisition is performed. In step 404, traffic is stored cyclically, and then step 406 is performed. In step 406, traffic samples are analyzed. In step 408, model data is stored. In step 410, suspicious traffic analysis is performed, and suspicious traffic is analyzed in conjunction with the model data and cyclical traffic. In step 412, the suspicious traffic is stored. In step 414, a report is generated to display the suspicious traffic to a user.

In the method according to the embodiment, a condition of the suspicious traffic is displayed to the user, which is beneficial for the user to perform further processing in time and improves network security. Moreover, an anomaly detection rule is updated with time, which improves network traffic anomaly detection accuracy and efficiency, is applicable to various traffic types, and satisfies the requirement of real-time anomaly detection.

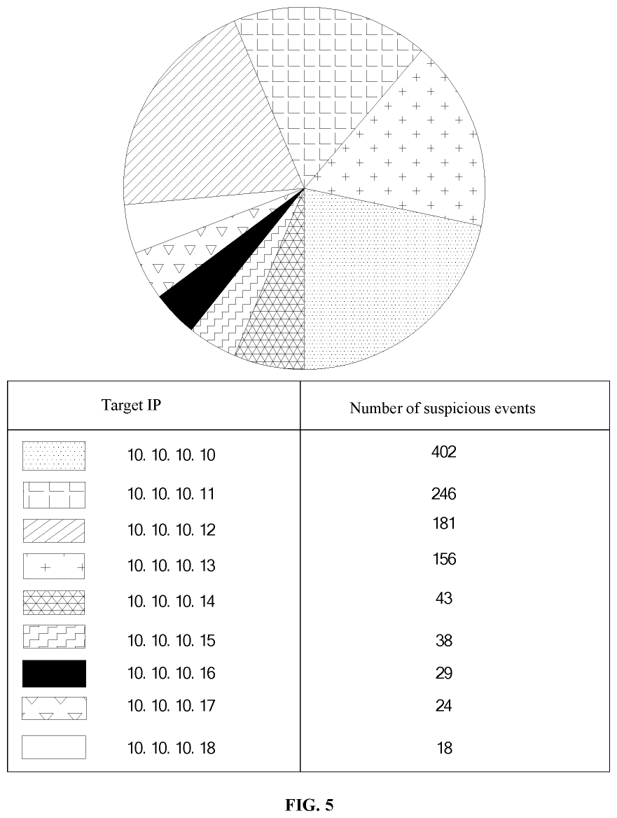

FIG. 5 is a diagram of a network traffic anomaly display interface according to an embodiment. As shown in FIG. 5, the network traffic anomaly display interface according to the embodiment intuitively displays a number of suspicious events happening to a suspicious target IP through a pie chart and displays the number of suspicious events corresponding to the target IP through a table. For example, a number of suspicious events for a target IP 10.10.10.10 is 402, a number of suspicious events for a target IP 10.10.10.11 is 246, and so on, so that a user can more intuitively learn a condition of suspicious traffic, which is beneficial for the user to perform further processing in time and improves network security. Moreover, an anomaly detection rule is updated with time, which improves network traffic anomaly detection accuracy and efficiency, is applicable to various traffic types, and satisfies the requirement of real-time anomaly detection.

In the network traffic anomaly detection method, the network traffic anomaly detection apparatus, the computer device and the computer-readable storage medium according to the embodiments described above, the network traffic anomaly detection model data is established according to the network traffic data collected in real time within the preset time period, and it is detected whether the network traffic data collected after the preset time period is anomalous according to the network traffic anomaly detection model data, which improves the network traffic anomaly detection accuracy and efficiency, is applicable to the various traffic types, and satisfies the requirement of real-time anomaly detection.

The steps in the method embodiments described above may be adjusted in terms of their order, combined, and deleted according to practical requirements.

The units in the apparatus embodiments described above may be combined, divided, and deleted according to practical requirements.

All or part of the steps of the method in the embodiments described above may be implemented by related hardware instructed by programs. The programs may be stored in a computer-readable storage medium. The storage medium includes a read-only memory (ROM), a random access memory (RAM), a programmable read-only memory (PROM), an erasable programmable read only memory (EPROM), a one-time programmable read-only memory (OTPROM), an electrically-erasable programmable read-only memory (EEPROM), a compact disc read-only memory (CD-ROM), or other optical disc memories, magnetic disc memories, magnetic tape memories, or any other computer-readable medium capable of carrying or storing data.

What is claimed is:

1. A network traffic anomaly detection method, comprising:
collecting network traffic data in real time, and storing the network traffic data in a first preset database;
determining network traffic anomaly detection model data according to network traffic data collected within a preset time period stored in the first preset database; and
determining whether network traffic data collected after the preset time period is anomalous according to the network traffic anomaly detection model data.

2. The method of claim 1, wherein determining the network traffic anomaly detection model data according to the network traffic data collected within the preset time period comprises:
determining a first outlier factor corresponding to each of the network traffic data collected within the preset time period based on a local outlier factor algorithm;
in response to determining that the first outlier factor is greater than a first preset threshold, labelling the each of the network traffic data corresponding to the first outlier factor with an anomalous state;
in response to determining that the first outlier factor is less than or equal to the first preset threshold, labelling the each of the network traffic data corresponding to the first outlier factor with a normal state; and
determining the network traffic anomaly detection model data according to the labelled each of the network traffic data.

3. The method of claim 1, wherein determining whether the network traffic data collected after the preset time period is anomalous according to the network traffic anomaly detection model data comprises:
forming a data set according to the network traffic data collected after the preset time period and the network traffic anomaly detection model data;
determining a second outlier factor of the network traffic data collected after the preset time period in the data set based on a local outlier factor algorithm;
in response to determining that the second outlier factor is greater than a second preset threshold, determining that the network traffic data corresponding to the second outlier factor is anomalous; and
in response to determining that the second outlier factor is less than or equal to the second preset threshold, determining that the network traffic data corresponding to the second outlier factor is normal.

4. The method of claim 1, further comprising:
in response to determining that the network traffic data collected after the preset time period is anomalous, adding the network traffic data collected after the preset time period to a second preset database; and
parsing and counting network traffic data in the second preset database to obtain a counting result, and updating a display content of an anomaly display interface according to the counting result.

5. The method of claim 1, wherein
the network traffic data comprises an access time period, an access source Internet protocol (IP) address, an access destination IP address, an access source port, an access destination port, a number of input bytes and a number of output bytes.

6. A network traffic anomaly detection apparatus, comprising a processor and a memory for storing execution instructions that when executed by the processor causes the processor to perform steps in following units:
a collection unit, which is configured to collect network traffic data in real time, and store the network traffic data in a first preset database;
an establishment unit, which is configured to determine network traffic anomaly detection model data according to network traffic data collected within a preset time period stored in the first preset database; and
a determining unit, which is configured to determine whether network traffic data collected after the preset time period is anomalous according to the network traffic anomaly detection model data.

7. The apparatus of claim 6, wherein
the determining unit is further configured to determine a first outlier factor corresponding to each of the network traffic data collected within the preset time period based on a local outlier factor algorithm;
the network traffic anomaly detection apparatus further comprises:
a labelling unit, which is configured to: in response to determining that the first outlier factor is greater than a first preset threshold, label the each of the network traffic data corresponding to the first outlier factor with an anomalous state; and in response to determining that the first outlier factor is less than or equal to the first preset threshold, label the each of the network traffic data corresponding to the first outlier factor with a normal state; and
the establishment unit is further configured to determine the network traffic anomaly detection model data according to the labelled each of the network traffic data.

8. The apparatus of claim 6, wherein the units further comprise:
a forming unit, which is configured to form a data set according to the network traffic data collected after the preset time period and the network traffic anomaly detection model data; wherein
the determining unit is further configured to determine a second outlier factor of the network traffic data collected after the preset time period in the data set based on a local outlier factor algorithm;
the determining unit is further configured to: in response to determining that the second outlier factor is greater than a second preset threshold, determine that the network traffic data corresponding to the second outlier factor is anomalous; and
the determining unit is further configured to: in response to determining that the second outlier factor is less than or equal to the second preset threshold, determine that the network traffic data corresponding to the second outlier factor is normal.

9. The apparatus of claim 6, wherein the units further comprise:
an adding unit, which is configured to: in response to determining that the network traffic data collected after the preset time period is anomalous, add the network traffic data collected after the preset time period to a second preset database; and
a parsing unit, which is configured to parse and count network traffic data in the second preset database to obtain a counting result, and update a display content of an anomaly display interface according to the counting result.

10. The apparatus of claim 6, wherein the network traffic data comprises an access time period, an access source Internet protocol (IP) address, an access destination IP address, an access source port, an access destination port, a number of input bytes and a number of output bytes.

11. A computer device, comprising a processor which, when executing computer programs stored in a memory, implements the network traffic anomaly detection method of claim 1.

12. A non-transitory computer-readable storage medium, storing computer programs thereon, wherein the computer programs, when executed by a processor, implement the network traffic anomaly detection method of claim 1.

13. The method of claim 2, further comprising:
in response to determining that the network traffic data collected after the preset time period is anomalous, adding the network traffic data collected after the preset time period to a second preset database; and
parsing and counting network traffic data in the second preset database to obtain a counting result, and updating a display content of an anomaly display interface according to the counting result.

14. The method of claim 4, further comprising:
in response to determining that the network traffic data collected after the preset time period is anomalous, adding the network traffic data collected after the preset time period to a second preset database; and
parsing and counting network traffic data in the second preset database to obtain a counting result, and updating a display content of an anomaly display interface according to the counting result.

15. The method of claim 2, wherein
the network traffic data comprises an access time period, an access source Internet protocol (IP) address, an access destination IP address, an access source port, an access destination port, a number of input bytes and a number of output bytes.

16. The method of claim 3, wherein
the network traffic data comprises an access time period, an access source Internet protocol (IP) address, an access destination IP address, an access source port, an access destination port, a number of input bytes and a number of output bytes.

17. The apparatus of claim 7, wherein the units further comprises:
an adding unit, which is configured to: in response to determining that the network traffic data collected after the preset time period is anomalous, add the network traffic data collected after the preset time period to a second preset database; and
a parsing unit, which is configured to parse and count network traffic data in the second preset database to obtain a counting result, and update a display content of an anomaly display interface according to the counting result.

18. The apparatus of claim 8, wherein the units further comprises:
an adding unit, which is configured to: in response to determining that the network traffic data collected after the preset time period is anomalous, add the network traffic data collected after the preset time period to a second preset database; and
a parsing unit, which is configured to parse and count network traffic data in the second preset database to obtain a counting result, and update a display content of an anomaly display interface according to the counting result.
